(19) United States
(12) Patent Application Publication
(10) Pub. No.: US 2017/0075452 A1
(43) Pub. Date: Mar. 16, 2017

(54) DISPLAY DEVICE WITH TOUCH SCREEN AND METHOD FOR MANUFACTURING THE DISPLAY DEVICE

(71) Applicant: Samsung Display Co., Ltd., Yongin-si (KR)

(72) Inventors: Sung Hoon KIM, Yongin-si (KR); Sun Hee LEE, Yongin-si (KR)

(21) Appl. No.: 15/160,901

(22) Filed: May 20, 2016

(30) Foreign Application Priority Data
Sep. 10, 2015 (KR) 10-2015-0128617

(51) Int. Cl. G06F 3/044; G06F 3/041

(52) U.S. Cl. CPC G06F 3/044; G06F 3/0412; G06F 2203/04103; G06F 2203/04111

(57) ABSTRACT

A display device with a touch screen may include the following elements: a thin film transistor disposed on a first substrate; a display element that includes a first electrode connected to the thin film transistor, and a second electrode disposed on the first electrode; a plurality of first touch electrodes that are spaced apart from the first electrode on the first substrate; a plurality of second touch electrodes disposed on the first substrate in parallel with the first electrodes; a pixel definition layer that includes bridge contact holes through which the respective first touch electrodes are partially exposed; a bridge electrode that connects the first touch electrodes exposed through the bridge contact holes; and a second substrate facing the first substrate. The first electrode, the first touch electrodes and the second touch electrodes are formed of the same conductive material on the same layer.

### CROSS-REFERENCE TO RELATED APPLICATION

This application claims priority to and the benefit of Korean Patent Application No. 10-2015-0128617, filed on Sep. 10, 2015, in the Korean Intellectual Property Office; the entire contents of the Korean Patent Application are incorporated herein by reference in their entirety.

### BACKGROUND

Field

The present disclosure relates to a display device with a touch screen and relates to a manufacturing method of the display device.

Discussion of the Background

In display devices used in mobile devices, various ways can be used for selecting an object or an area displayed within a screen. A typical way is to use an interface device such as a keyboard, a remote controller, etc. Another way is to use a touch screen. The touch screen enables a user to directly select the area of the screen with one or more fingers, a stylus pen, or the like.

A display device with such a touch screen may be implemented with a touch sensing function separately produced and then attached to a display panel. The display device may also be implemented by an in-cell way in which a plurality touch electrodes and wirings are directly formed on a substrate of the display panel.

In order for a display device to include the touch electrodes and wirings for sensing touch or stylus interactions, one or more additional processes may be required for forming those elements on the display panel.

### SUMMARY

According to an embodiment, a display device with a touch screen may include the following elements: a first substrate; a thin film transistor disposed on the first substrate; a display element that includes a first electrode connected to the thin film transistor, and a second electrode disposed on the first electrode; a plurality of first touch electrodes that are spaced apart from the first electrode, each of which extends in a column direction on the first substrate; a plurality of second touch electrodes disposed on the first substrate in parallel with the first electrodes; a pixel definition layer that is disposed on the first electrode, the plurality of first touch electrodes and the plurality of second touch electrodes and that includes bridge contact holes through which the respective first touch electrodes are partially exposed; a bridge electrode that is disposed on the pixel definition layer and that connects the first touch electrodes exposed through the bridge contact holes; and a second substrate facing the first substrate.

In an embodiment, the first electrode, the first touch electrodes and the second touch electrodes may be formed of the same conductive material on the same layer.

In an embodiment, the bridge electrode and the second electrode may be formed of the same conductive material on the same layer.

In an embodiment, the display element may further include an organic light emitting layer that emits light with a specific color by the first electrode and the second electrode.

In an embodiment, the first electrode may include an anode electrode, and wherein the second electrode includes a cathode electrode.

According to an embodiment, a display device with a touch screen may include the following elements: a first substrate; a thin film transistor disposed on the first substrate; a display element that includes a first electrode connected to the thin film transistor, and a second electrode disposed on the first electrode; a bridge electrode spaced apart from the first electrode on the first substrate; a pixel definition layer that is disposed on the first electrode and the bridge electrode and that includes first openings through which the bridge electrode is partially exposed; a dielectric layer that is disposed on the pixel definition layer and that includes second openings corresponding to the first openings of the pixel definition layer; a plurality of first touch electrodes disposed on the dielectric layer and extended in a first direction; a plurality of second touch electrodes spaced apart from the first touch electrodes and extended in a second direction crossing the first direction; and a second substrate facing the first substrate.

In an embodiment, the first touch electrodes adjacent to each other may be connected to the bridge electrode through the first openings and second openings.

In an embodiment, the first electrode and the bridge electrode may be formed of the same conductive material on the same layer.

In an embodiment, the first touch electrodes and the second touch electrodes may be formed of the same conductive material on the same layer.

In an embodiment, the bridge electrode may include an initialization power line for supplying an initialization power to the thin film transistor.

In an embodiment, the display element may further include an organic light emitting layer that emits light with a specific color by the first electrode and the second electrode.

In an embodiment, the first electrode may include an anode electrode, and wherein the second electrode includes a cathode electrode.

A method for manufacturing a display device with a touch screen may include the following steps: forming a thin film transistor on a first substrate; forming a passivation layer on the thin film transistor; forming a first electrode connected to the thin film transistor on the passivation layer and forming a first conductive pattern spaced apart from the first electrode on the passivation layer; forming a pixel definition layer with contact holes on the first electrode and the first conductive pattern, the first conductive pattern being partially exposed through the contact holes; forming a second electrode disposed on the pixel definition layer and partially overlapped with the first electrode, and forming a second conductive pattern disposed on the pixel definition layer and insulated from the second electrode; and forming a second substrate facing the first substrate on the first substrate.

In this method, the first conductive pattern may include a plurality of first touch electrodes spaced apart from the first electrode and extended in a column direction, and a plurality of second touch electrodes formed in parallel with the first electrodes, and the respective first touch electrodes may be partially exposed through the contact holes of the pixel definition layer.

In this method, the second conductive pattern may include a bridge electrode that connects the first touch electrodes exposed through the contact holes of the pixel definition layer.

In this method, the first electrode, the plurality of first touch electrodes and the plurality of second touch electrodes may be formed of the same conductive material on the same layer.

In this method, the second electrode and the second conductive pattern may be formed of the same conductive material on the same layer.

In this method, the second conductive pattern may include a plurality of first touch electrodes that are disposed on a dielectric layer placed on the pixel definition layer and that are extended in a first direction, and a plurality of second touch electrodes that are spaced apart from the first touch electrodes and that are extended in a second direction crossing the first direction.

In this method, the first conductive pattern may include a bridge electrode that connects the adjacent first touch electrodes to each other through the contact holes.

This method may further include forming an organic light emitting layer for emitting light with a specific color between the first electrode and the second electrode.

According to embodiments, since bridge electrodes of a display device are produced simultaneously with electrodes of pixels of the display device using a same material layer, no additional mask process or additional material layer may be required for the formation of the bridge electrodes. Accordingly, the manufacturing process of the display device may be simplified, and related manufacturing cost may be minimized, and/or a thickness of the display device may be minimized.

### BRIEF DESCRIPTION OF THE DRAWINGS

FIG. 1 is a schematic layout view (or plan view) of a display device with a touch screen according to an embodiment.

FIG. 2 is a cross-sectional view taken along the line I-I′ of FIG. 1.

FIG. 3A to FIG. 3H are cross-sectional views for sequentially showing manufacturing processes of the display device with the touch screen according to the embodiment.

FIG. 4 is a schematic layout view (or plan view) of a display device with a touch screen according to an embodiment.

FIG. 5 is a cross-sectional view taken along the line II-II′ of FIG. 4.

FIG. 6A to FIG. 6H are cross-sectional views for sequentially showing manufacturing processes of the display device with the touch screen according to an embodiment.

### DETAILED DESCRIPTION

Examples of embodiments are described with reference to the accompanying drawings.

Possible embodiments are not limited to the example embodiments described below and may be implemented in various ways.

Like reference numerals may indicate like constituent elements in the specification.

Sizes and thicknesses of constituent members shown in the accompanying drawings are given for better understanding and ease of description. Embodiments are not limited to the illustrated sizes and thicknesses.

Although the terms “first”, “second”, etc. may be used herein to describe various elements, these elements should not be limited by these terms. These terms may be used to distinguish one element from another element. Thus, a first element discussed in this application may be termed a second element without departing from embodiments. The description of an element as a “first” element may not require or imply the presence of a second element or other elements. The terms “first”, “second”, etc. may also be used herein to differentiate different categories or sets of elements. For conciseness, the terms “first”, “second”, etc. may represent “first-category (or first-set)”, “second-category (or second-set)”, etc., respectively.

In the present specification, when a first element (such as a layer, film, region, or substrate) is referred to as being “on” a second element, the first element can be directly on the second element, or one or more intervening elements may be present.

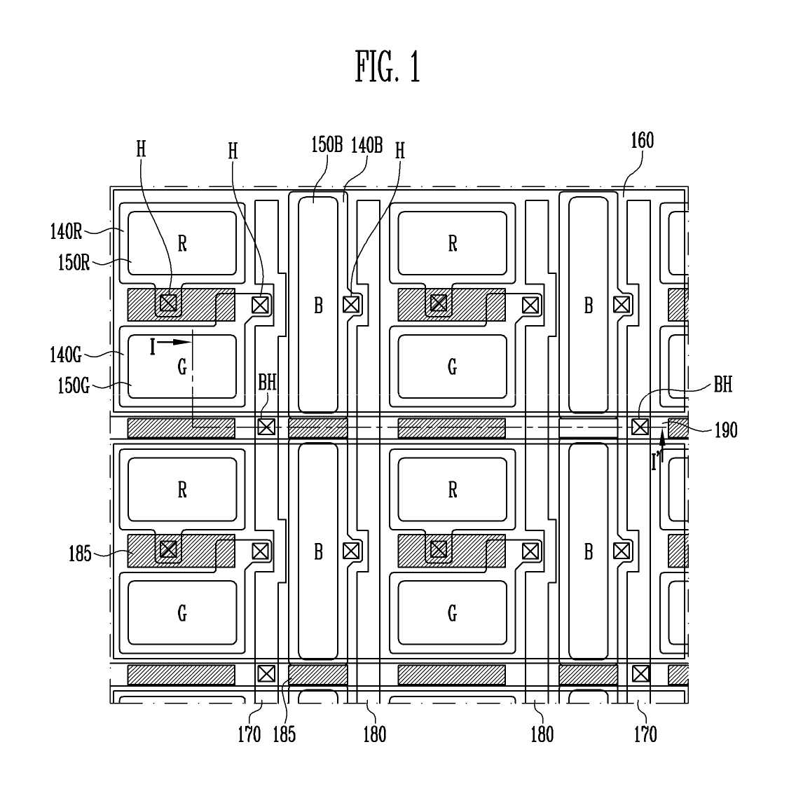

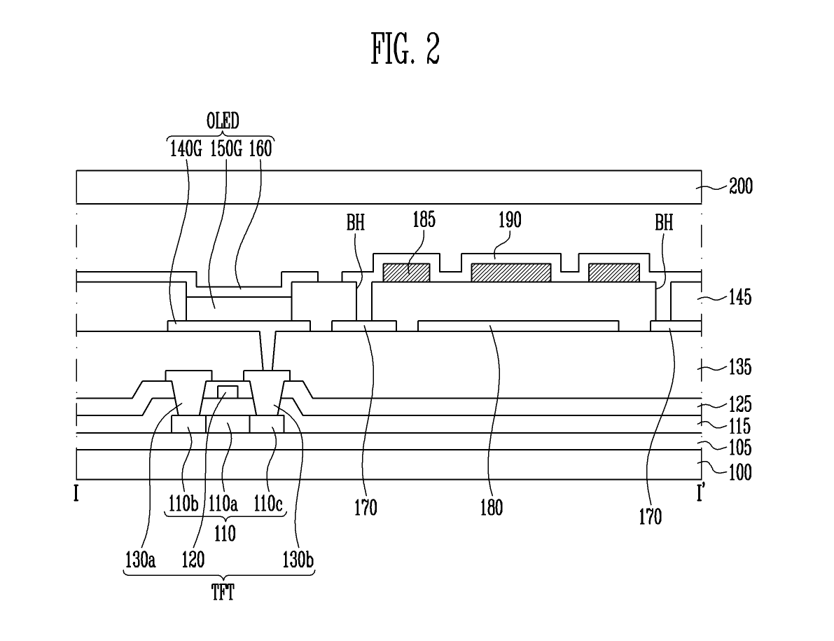

FIG. 1 is a schematic layout view of a display device with a touch screen according to an embodiment, and FIG. 2 is a cross-sectional view taken along the line I-I′ of FIG. 1.

An organic light emitting display device is described as an example of the display device with the touch screen. However, the present disclosure is not necessarily limited thereto. For example, the present disclosure may be applicable to a liquid crystal display device, etc.

Referring to FIG. 1 and FIG. 2, the display device with the touch screen according to the embodiment includes a first substrate 100 in which a plurality of pixels including red pixels R, green pixels G, and blue pixels B are formed, and a second substrate 200 facing the first substrate 100.

The red pixels R and the green pixels G are alternately arranged in the vertical direction on the first substrate 100. The blue pixels B are arranged along one side of the red pixels R and the green pixels G. Each of the red pixel R and the green pixel G extends in the horizontal direction to have a wider width than the blue pixel B. In contrast, each blue pixel B extends only in the vertical direction, thereby having a relatively narrow width.

The blue pixels B are successively arranged in the vertical direction. Pixel columns consisting of only the blue pixels B and pixel columns consisting of the red pixels R and the green pixels G are alternately arranged as shown in FIG. 1.

Each red pixel R includes a first electrode 140R (or pixel electrode 140R) for the red pixel, a contact hole H for the first electrode 140R, and an organic red light emitting layer 150R. The first electrode 140R for the red pixel has a similar shape to the organic red light emitting layer 150R, but has a protrusion extending downward differently with the organic red light emitting layer 150R. The protrusion of the first electrode 140R for the red pixel is electrically connected to an output of a driving transistor through the contact hole H.

Each green pixel G includes a first electrode 140G (or pixel electrode 140G) for the green pixel, a contact hole H for the first electrode 140G, and an organic green light emitting layer 150G. The first electrode 140G for the green pixel has a similar shape to the organic green light emitting layer 150G, but has a protrusion extending upward differently with the organic green light emitting layer 150G. An end of the protrusion of the first electrode 140G is electrically connected to an output of a driving transistor through the contact hole H.

Each blue pixel B includes a first electrode 140B (or pixel electrode 140B) for the blue pixel, a contact hole H for the first electrode 140B, and an organic green light emitting layer 150B. The first electrode 140B for the blue pixel has a similar shape to the organic green light emitting layer 150B, but has a protrusion extending to the right differently with the organic green light emitting layer 150R. The protrusion of the first electrode 140B is electrically connected to an output of a driving transistor through the contact hole H.

Spacers 185 are disposed in every space between the red pixels R and the green pixels G and between the adjacent blue pixels B so that the first substrate 100 and the second substrate 200 are maintained with a specific space therebetween. The respective spacers 185 may have different sizes depending on the places they are arranged. For example, an size of the spacer 185 arranged between the red pixel R and the green pixel G may be larger than that of the spacer 185 arranged between the blue pixels B.

Second electrodes 160 (or corresponding electrodes 160) are respectively disposed on the red pixels R, the green pixels G, and the blue pixels B.

Accordingly, each red pixel R includes an organic light emitting diode OLED which consists of the first electrode 140R for the red pixel, the organic red light emitting layer 150R, and the second electrode 160. Similarly, each green pixel G includes an organic light emitting diode OLED which consists of the first electrode 140G for the green pixel, the organic green light emitting layer 150G, and the second electrode 160. Also similarly, each blue pixel B includes an organic light emitting diode OLED which consists of the first electrode 140B for the blue pixel, the organic blue light emitting layer 150B, and the second electrode 160.

A plurality of first touch electrodes 170 and a plurality of second touch electrodes 180 are formed on the first substrate 100 and are configured for sensing touches on the display device performed by a user of the display device. The first touch electrodes 170 are successively arranged in the vertical direction like the blue pixels B, and the second touch electrodes 180 are arranged in parallel with the first touch electrodes 170.

Each first touch electrode 170 is electrically connected to the adjacent first touch electrode 170 through a bridge electrode 190. Each second touch electrode 180 is electrically connected to the adjacent second touch electrode 180 through a bridge pattern (not shown).

Hereinafter, the display device with the touch screen according to the embodiment will be described on the basis of the stacking sequence with reference to FIG. 2.

The display device with the touch screen according to the embodiment includes the first substrate 100 on which a thin film transistor TFT and an organic light emitting diode OLED are formed, and the second substrate 200 facing the first substrate 100.

The first substrate 100 may be a glass substrate. The first substrate 100 may also be either one of a film substrate and a plastic substrate, each including a polymeric organic material with flexibility. The second substrate 200 is disposed on the first substrate 100 for sealing it, and may be formed of the same material as the first substrate 100. In the case of a top emissive type or a dual emission type display device, the second substrate 200 is formed of a transparent material, while it is formed of an opaque material in the case of a bottom emission type.

In this embodiment, the first substrate 100 means a substrate with the thin film transistor TFT and the organic light emitting diode OLED, and the second substrate 200 means a substrate facing the first substrate 100. This is only for ease of description, so terms and positions for the substrates may be changed. For example, the first substrate 100 and the second substrate 200 may be respectively referred to as a lower substrate and an upper substrate.

A buffer layer 105 is disposed on the first substrate 100. The buffer layer 105 prevents impurities from diffusing into the thin film transistor TFT. The buffer layer 105 may be formed of silicon nitride (SiNx), silicon oxide (SiOx), silicon oxynitride (SiOxNy), or the like. This buffer layer 105 may be omitted depending on the formation material of the first substrate 100 and the process condition.

A semiconductor pattern 110 is disposed on the buffer layer 105. The semiconductor pattern 110 is formed of a semiconductor material, and functions as an active layer of the thin film transistor TFT. This semiconductor pattern 110 includes a source region 110b, a drain region 110c, and a channel region 110a interposed between the source region 110b and the drain region 110c. The semiconductor pattern 110 may be formed of an inorganic semiconductor material or an organic semiconductor material. The source region 110b and the drain region 110c may be doped with n-type impurities or p-type impurities.

An interlayer insulating layer 115 is disposed on the semiconductor pattern 110.

A gate electrode 120 is disposed on the interlayer insulating layer 115. The gate electrode 120 is formed to cover an area corresponding to the channel region 110a of the semiconductor pattern 110.

A gate insulating layer 125 is disposed on the gate electrode 120.

A source electrode 130a and a drain electrode 130b are disposed on the gate insulating layer 125. The source electrode 130a and the drain electrode 130b are respectively connected to the source region 110b and the drain region 110c of the semiconductor pattern 110 through openings formed at the interlayer insulating layer 115 and the gate insulating layer 125.

The gate electrode 120, the source electrode 130a, and the drain electrode 130b forms a thin film transistor TFT. The thin film transistor TFT is not necessarily limited to the structure described above, and various types of thin film transistors may be applicable to the present disclosure. For example, differently with the thin film transistor of a top gate type described above, a bottom gate type thin film transistor in which a gate electrode 120 is formed below the semiconductor pattern 110 may also be applicable to the present disclosure.

A passivation layer 135 (which may be an insulating layer) is disposed on the source electrode 130a and the drain electrode 130b. The passivation layer 135 covers the thin film transistor TFT, and may include one or more layers. In detail, the passivation layer 135 may include an organic insulating material which is transparent and has fluidity. Due to those properties of the material, the passivation layer 135 can flatten a top surface of the uneven first substrate 100. The organic insulating material for the formation of the passivation layer 135 may be any one selected from a group including acryl resin, benzo cyclo butene (BCB), polyimide resin (PI), polyamide resin (PA), and phenol resin.

On the passivation layer 135, a first electrode 140G for the green pixel, a first touch electrode 170 spaced apart from the first electrode 140G for the green pixel, and a second touch electrode 180 spaced apart from the first touch electrode 170 are disposed. A flat side of the passivation layer 135 may directly contact each of a flat side of the first electrode 140G, flat sides of second touch electrodes 180, and flat sides of first touch electrodes 170. The flat side of the first electrode 140G, the flat sides of second touch electrodes 180, and the flat sides of first touch electrodes 170 may be coplanar with one another.

The first electrode 140G for the green pixel is electrically connected to the drain electrode 130b of the thin film transistor TFT through a contact hole formed at the passivation layer 135.

The first touch electrode 170 is spaced apart from the first electrode 140G for the green pixel on the passivation layer 135. The first touch electrode 170 is formed of the same conductive material as the first electrode 140G for the green pixel, and functions as a driving electrode of the touch screen.

The second touch electrode 180 is spaced apart from the first touch electrode 170 on the passivation layer 135. The second touch electrode 180 is formed of the same conductive material as the first electrode 140G for the green pixel, and functions as a receiving electrode of the touch screen.

A pixel definition layer 145 (which may be an insulating layer) is disposed on the first substrate 100 with the first electrode 140G for the green pixel, the first touch electrode 170, and the second touch electrode 180 so as to define an area where an organic green light emitting layer 150G will be formed. The pixel definition layer 145 exposes a partial top surface of the first electrode 140G for the green pixel, protruding along the edges of the pixels from the first substrate 100. In addition, the pixel definition layer 145 is patterned to have a bridge contact hole BH through which a part of the first touch electrode 170 is exposed.

The organic green light emitting layer 150G is disposed in the area surrounded by the pixel definition layer 145. The organic green light emitting layer 150G is illustrated as a single layer in FIG. 2, but it may be formed to have a multilayer structure. For example, the organic green light emitting layer 150G may include an electron injection layer, an electron transport layer, a hole injection layer, and a hole transport layer.

A second electrode 160 is disposed on the organic green light emitting layer 150G.

In this embodiment, the first electrode 140G for the green pixel functions as an anode electrode, while the second electrode 160 functions as a cathode electrode. However, the present disclosure is not necessarily limited thereto. For example, the first electrode 140G for the green pixel may function as the cathode electrode, while the second electrode 160 functioning as the anode electrode.

Functioning as the anode electrode, the first electrode 140G for the green pixel may be formed of a transparent conductive material whose work function is high, such as indium tin oxide (ITO), indium zinc oxide (IZO), zinc oxide (ZnO), indium oxide (In2O3), etc. In the case of a top emission type display device in which an image is displayed in the opposite direction to the first substrate 100, the first electrode 140G for the green pixel may further include a reflective layer. In this case, the reflection layer may include any one of silver (Ag), magnesium (Mg), aluminum (Al), platinum (Pt), palladium (Pd), gold (Au), nickel (Ni), neodymium (Nd), iridium (Ir), chromium (Cr), lithium (Li), ytterbium (Yb), and calcium (Ca), or a compound of two or more materials selected from the enumerated materials.

The first touch electrode 170 and the second touch electrode 180 are formed of the same conductive material as the first electrode 140G for the green pixel. That is, the first touch electrode 170 and the second touch electrode 180 may also be formed of a transparent conductive material whose work function is high, such as indium tin oxide (ITO), indium zinc oxide (IZO), zinc oxide (ZnO), indium oxide (In2O3), etc. In addition, in the case of the top emission type display device in which an image is displayed in the opposite direction to the first substrate 100, each of the first touch electrode 170 and the second touch electrode 180 may further include a reflective layer. In this case, the reflection layer may include any one of silver (Ag), magnesium (Mg), aluminum (Al), platinum (Pt), palladium (Pd), gold (Au), nickel (Ni), neodymium (Nd), iridium (Ir), chromium (Cr), lithium (Li), ytterbium (Yb), and calcium (Ca), or a compound of two or more materials selected from the enumerated materials.

Functioning as the cathode electrode, the second electrode 160 may be formed of a metallic material, such as silver (Ag), magnesium (Mg), aluminum (Al), platinum (Pt), palladium (Pd), gold (Au), nickel (Ni), neodymium (Nd), iridium (Ir), chromium (Cr), lithium (Li), and calcium (Ca). In the case of the top emission type display device with the touch screen, the second electrode 160 may also be formed of a transparent conductive material with a high work function to enable light to pass through, such as indium tin oxide (ITO), indium zinc oxide (IZO), zinc oxide (ZnO), indium oxide (In2O3), etc.

Meanwhile, a bridge electrode 190 is disposed to be spaced apart from the second electrode 160 on the pixel definition layer 145. The bridge electrode 190 is formed of the same material as the second electrode 160, and is connected to the first touch electrode 170 through the bridge contact hole BH. Flat sides (e.g., top sides) of the pixel definition layer 145 may directly contact flat sides of the second electrode 160 and flat sides of the bridge electrode 190. The flat sides of the second electrode 160 and the flat sides of the bridge electrode 190 may be coplanar with one another.

Accordingly, the first touch electrode 170 is connected to the adjacent first touch electrode 170 through the bride electrode 190, and thus the connected first touch electrodes 170 can function as driving electrodes of the touch screen.

A spacer 185 is disposed between the pixel definition layer 145 and the bridge electrode 190. The spacer 185 is formed to protrude toward the second substrate 200 from the pixel definition layer 145. The pixel definition layer 145 and the spacer 185 may be formed as an inseparable unit through a photolithography process using a photosensitive material.

As described above, in the display device with the touch screen according to the embodiment, the first touch electrode 170 and the second touch electrode 180 functioning as the driving electrode and the receiving electrode of the touch screen are formed simultaneously with the first electrode 140G for the green pixel. Accordingly, since an additional mask process for the formation of the first and second touch electrodes 170 and 180 is omitted, the manufacturing process is simplified and manufacturing cost is also reduced.

In addition, in the display device with the touch screen according to the embodiment, each of the first and second touch electrodes 170 and 180 is formed in an in-cell type. Accordingly, even if outer surfaces of the first substrate 100 and the second substrate 200 are etched by an etching process, the first and second touch electrodes 170 and 180 are not affected by such an etching. That is, the etching process for the outer surfaces of the first substrate 100 and the second substrate 200 can be performed, giving no harm to the first and second touch electrodes 170 and 180. As a result, according to the embodiment, the slimmer display device with the touch can be realized by reducing the overall thickness of the substrates.

In addition, since the first and second touch electrodes 170 and 180 are formed in the in-cell type, a film that is used in an on-cell type to protect the touch electrodes is omitted in this embodiment, and thus the manufacturing cost can be reduced.

Hereinafter, a manufacturing method of the display device with the touch screen according to the embodiment will be described in detail.

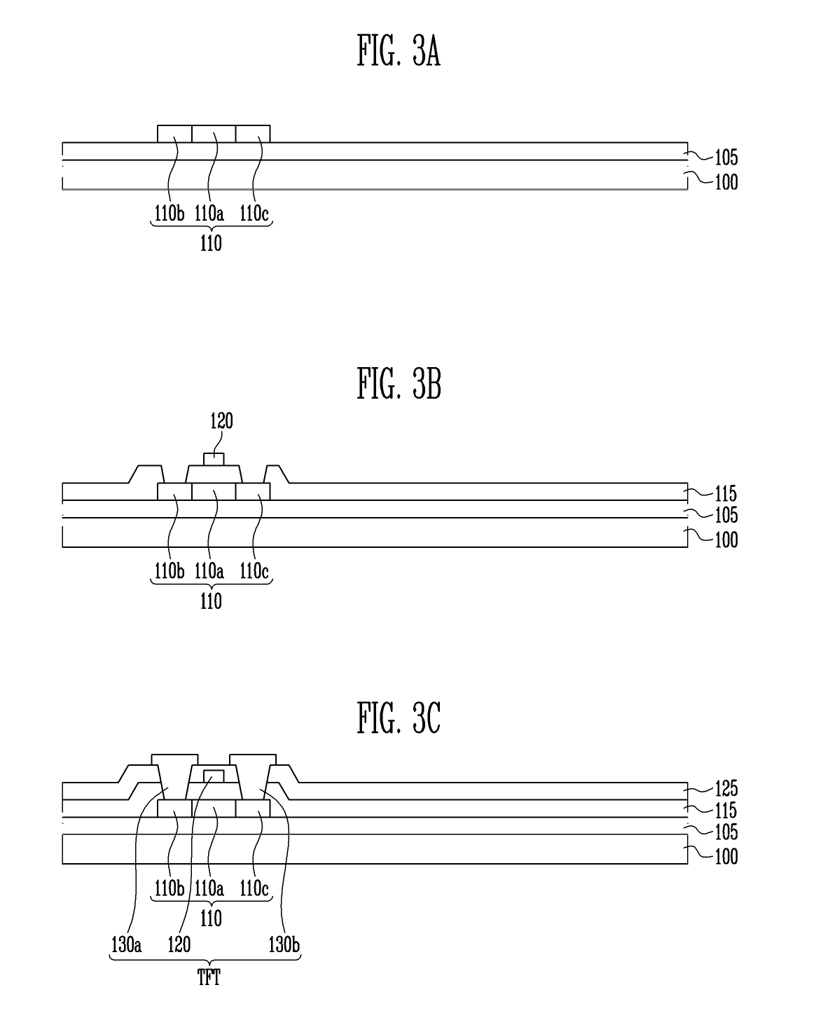

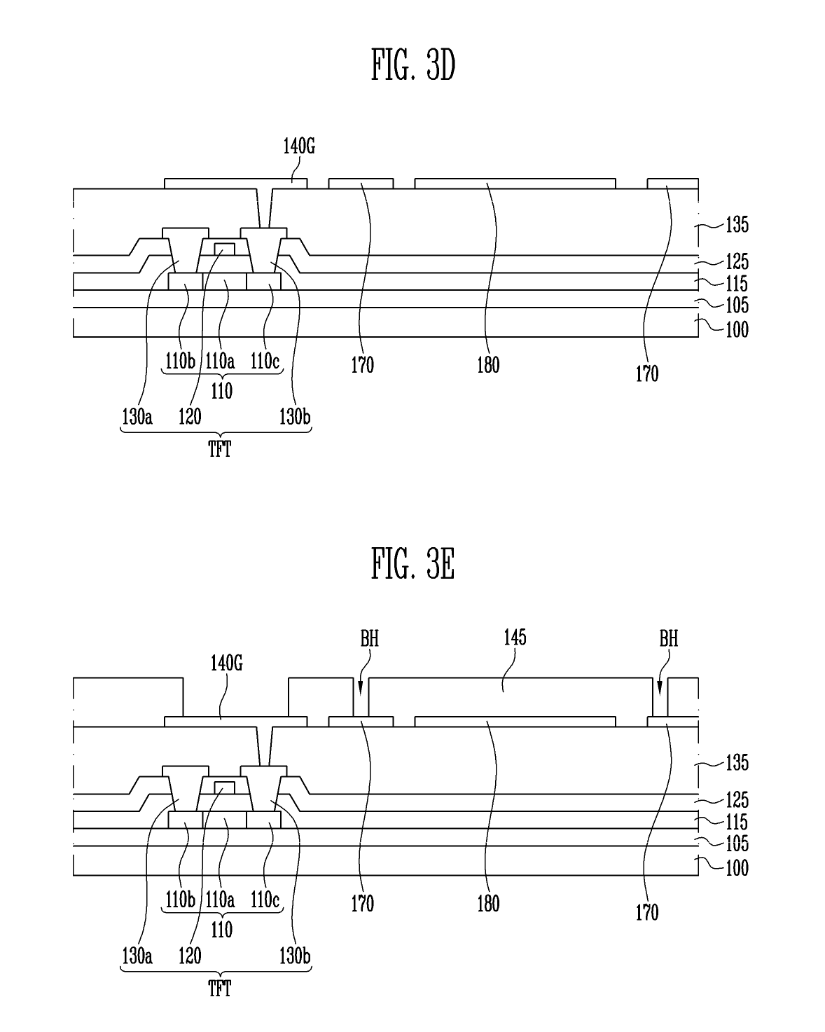

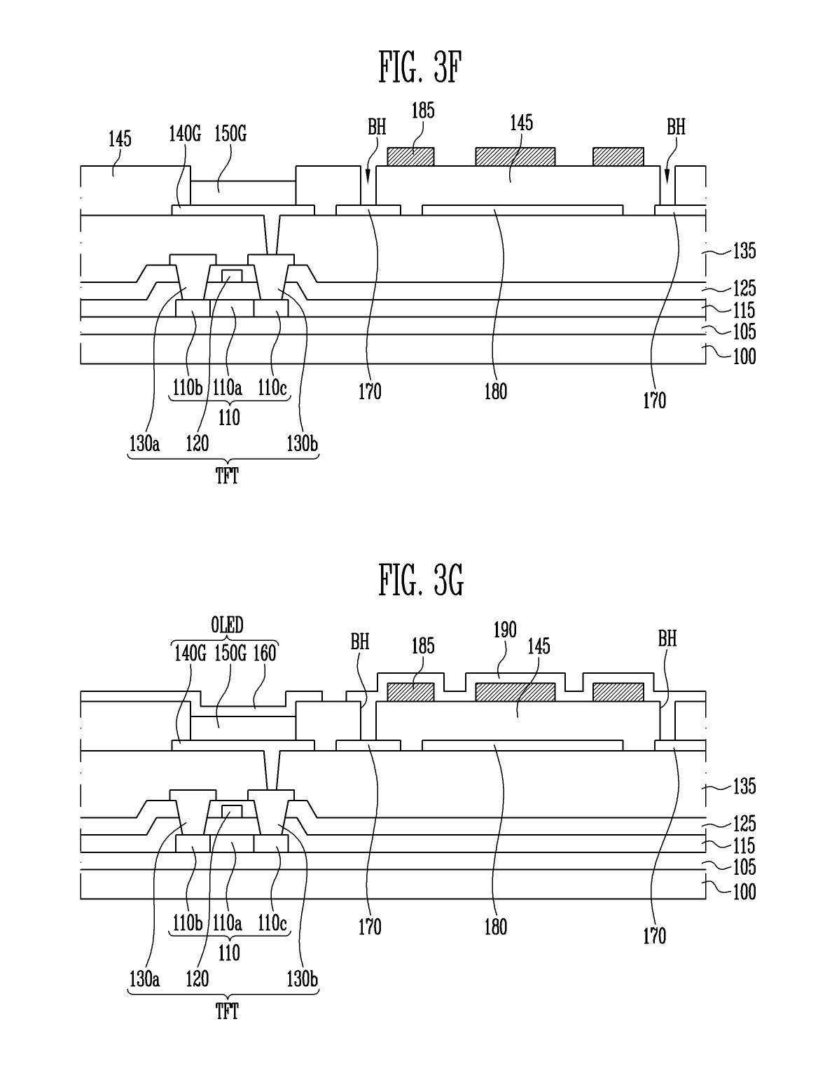

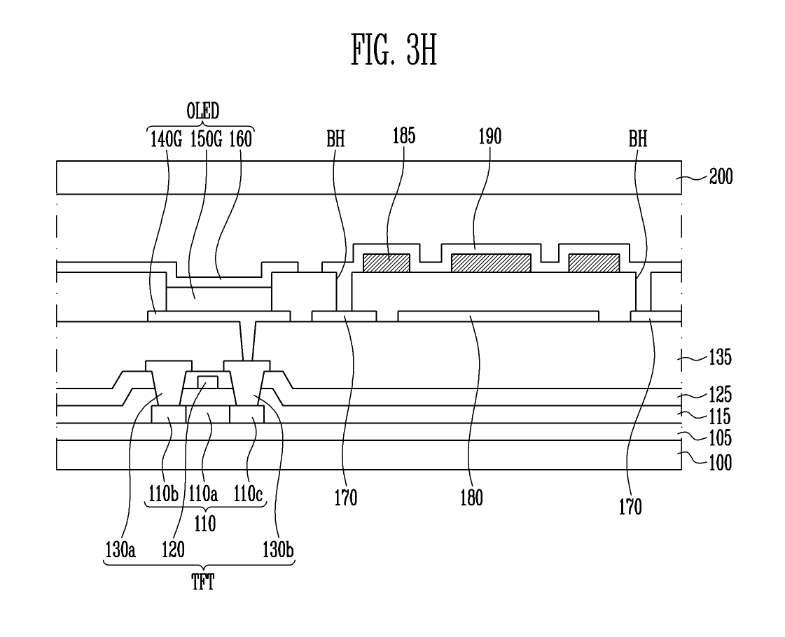

FIG. 3A to FIG. 3H are cross-sectional views for sequentially showing manufacturing processes of the display device with the touch screen according to the embodiment.

Referring to FIG. 3A, the buffer layer 105 are first formed on the first substrate 100, and then the semiconductor pattern 110 is formed on the buffer layer 105.

It is preferable that the first substrate 100 is formed of a material with excellent mechanical strength and size stability. As the preferable material for the formation of the first substrate 100, glass, metal, ceramic, plastic (such as polycarbonate resin, acryl resin, polyvinyl chloride resin, polyethylene terephthalate resin, polyimide resin, polyester resin, epoxy resin, silicon resin, and fluorine resin), and so forth may be used.

The buffer layer 105 may be formed to protect driving elements that will be formed by subsequent processes from impurities, such as alkali ion, etc. which may leak from the first substrate 100. The buffer layer 105 may be formed of silicon nitride (SiNx), silicon oxide (SiOx), silicon oxynitride (SiOxNy), or the like. This buffer layer 105 may be omitted depending on the formation material of the first substrate 100.

The semiconductor pattern 110 is formed on the buffer layer 105, and includes the channel region 110a with no impurity, the source region 110b and the drain region 110c in which an impurity is injected. The impurity may comprise an n-type impurity or a p-type impurity.

Referring to FIG. 3B, the interlayer insulating layer 115 is formed to entirely cover the buffer layer 105 with the semiconductor pattern 110 thereon. Then, the gate electrode 120 is formed on the interlayer insulating layer 115.

The interlayer insulating layer 115 is formed on the semiconductor pattern 110, and includes the openings through which the source region 110b and the drain region 110c are partially exposed. The interlayer insulating layer 115 may be a single layer formed of any one selected among inorganic insulating materials such as silicon nitride (SiNx), silicon oxide (SiOx), and silicon oxynitride (SiOxNy), or a multi-layer in which two or more layers formed with the materials selected from silicon nitride (SiNx), silicon oxide (SiOx), and silicon oxynitride (SiOxNy) are included.

The gate electrode 120 is formed on the interlayer insulating layer 115 to correspond to the channel region 110a.

The gate electrode 120 may be formed of a metallic material, two or more metallic materials, or an alloy of the metallic materials. In detail, the gate electrode 120 may be a single layer formed with a material or a compound of two or more materials selected from a group including molybdenum (Mo), tungsten (W), aluminum neodymium (AlNd), titanium (Ti), aluminum (Al), silver (Ag), and an alloy thereof. Differently, to reduce wiring resistance, the gate electrode 120 may have a multilayer structure in which two or more layers formed with low resistive materials such as molybdenum (Mo), aluminum (Al), and silver (Ag) are included.

Referring to FIG. 3C, the gate insulating layer 125 is formed on the gate electrode 120. Then, the source electrode 130a and the drain electrode 130b are formed on the gate insulating layer 125.

The gate insulating layer 125 is formed of an organic insulating material or an inorganic insulating material on the interlayer insulating layer 115, and includes the openings through which the source region 110b and the drain region 110c are partially exposed.

The source electrode 130a and the drain electrode 130b may be formed of a metallic material, two or more metallic materials, or an alloy of the metallic materials. In detail, each of the source electrode 130a and the drain electrode 130b may be a single layer formed with a material or a compound of two or more materials selected from a group including molybdenum (Mo), tungsten (W), molybdenum tungsten (MoW), aluminum neodymium (AlNd), titanium (Ti), aluminum (Al), silver (Ag), and an alloy thereof. Differently, to reduce wiring resistance, each of the source electrode 130a and the drain electrode 130b may have a multilayer structure in which two or more layers formed with low resistive materials such as molybdenum (Mo), aluminum (Al), and silver (Ag) are included.

Referring to FIG. 3D, the passivation layer 135 is formed on the source electrode 130a and the drain electrode 130b. Then, the first electrode 140G for the green pixel, the first touch electrode 170, and the second touch electrode 180 are formed on the first substrate 100 with the passivation layer 135 thereon.

The passivation layer 135 includes a contact hole through which the drain electrode 130b is partially exposed. The contact hole of the passivation layer 135 is formed through a photolithography process. The passivation layer 135 may be formed of an organic insulating material which is transparent and has fluidity so as to flatten a top surface of the uneven first substrate 100.

The first electrode 140G for the green pixel is electrically connected to the drain electrode 130b through the contact hole formed at the passivation layer 135.

The first touch electrode 170 is spaced apart from the first electrode 140G for the green pixel on the passivation layer 135. The first touch electrode 170 is formed of the same conductive material as the first electrode 140G for the green pixel, and functions as a driving electrode of the touch screen.

The second touch electrode 180 is spaced apart from the first touch electrode 170 on the passivation layer 135. The second touch electrode 180 is formed of the same conductive material as the first electrode 140G for the green pixel, and functions as a receiving electrode of the touch screen.

Referring to FIG. 3E, the pixel definition layer 145 is formed on the first substrate 100 with the first electrode 140G for the green pixel, the first touch electrode 170, and the second touch electrode 180 so as to define an area where an organic green light emitting layer 150G will be formed. The pixel definition layer 145 exposes a partial top surface of the first electrode 140G for the green pixel, protruding along the edges of the pixels from the first substrate 100.

In addition, the pixel definition layer 145 is patterned to have the bridge contact hole BH through which a part of the first touch electrode 170 is exposed.

Referring to FIG. 3F, the organic green light emitting layer 150G are formed in the area surrounded by the pixel definition layer 145. Then, the spacer 185 is formed on the pixel definition layer 145.

The organic green light emitting layer 150G includes a layer formed of an organic light emitting material. In general, the organic green light emitting layer 150G has a multilayer structure.

The spacer 185 is formed to protrude toward the second substrate 200 from the pixel definition layer 145. The pixel definition layer 145 and the spacer 185 may be formed as an inseparable unit through a photolithography process using a photosensitive material.

Referring to FIG. 3G, the second electrode 160 is formed on the organic green light emitting layer 150G. Simultaneously, the bridge electrode 190 is formed on the spacer 185. That is, the second electrode 160 and the bridge electrode 190 are simultaneously formed on the same layer.

The first electrode 140G for the green pixel, the organic green light emitting layer 150G, and the second electrode 160 form an organic light emitting diode OLED.

The bridge electrode 190 is electrically connected to the exposed first touch electrodes 170 through the bridge contact hole BH. Accordingly, the first touch electrodes 170 adjacent to each other are connected through the bride electrode 190, thereby functioning as the driving electrodes of the touch screen.

Referring to FIG. 3H, after the organic light emitting diode OLED and the bridge electrode 190 are formed, the second substrate 200 is formed. The second substrate 200 functions as an encapsulation member for separating the organic light emitting diode OLED from the outside.

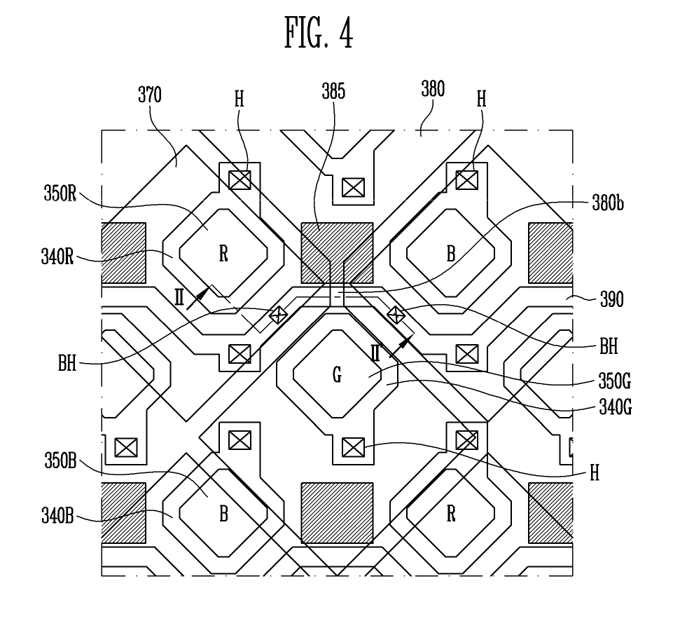

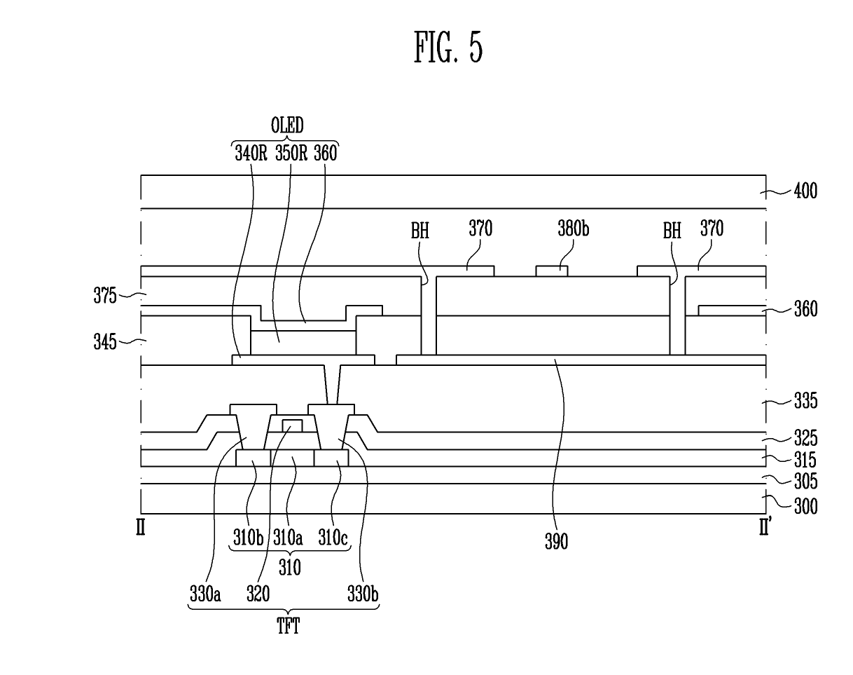

FIG. 4 is a schematic layout view of a display device with a touch screen according to an embodiment, and FIG. 5 is a cross-sectional view taken along the line II-II′ of FIG. 4.

Referring to FIG. 4 and FIG. 5, the display device with the touch screen according to an embodiment includes a first substrate 300 in which a plurality of pixels including red pixels R, green pixels G, and blue pixels B are formed, and a second substrate 400 facing the first substrate 300.

The green pixels G are successively arranged in the horizontal direction. The red pixels R and the blue pixels B are alternately arranged in the horizontal direction. Pixel columns consisting of only the green pixels G and pixel columns consisting of the red pixels R and the blue pixels B are alternately arranged.

As shown in FIG. 4, two red pixels R and two blue pixels B are diagonally positioned, centering one green pixel G. The two red pixels R face each other, centering the green pixel G. Similarly, the two blue pixels B face each other, centering the green pixel G.

Each red pixel R includes a first electrode 340R for the red pixel, a contact hole H for the first electrode 340R, and an organic red light emitting layer 350R. The first electrode 340R for the red pixel has a similar shape to the organic red light emitting layer 350R, but has a protrusion extending upward differently with the organic red light emitting layer 350R. The protrusion of the first electrode 340R for the red pixel is electrically connected to an output of a driving transistor through the contact hole H.

Each green pixel G includes a first electrode 340G for the green pixel, a contact hole H for the first electrode 340G, and an organic green light emitting layer 350G. The first electrode 340G for the green pixel has a similar shape to the organic green light emitting layer 350R, but has a protrusion extending downward differently with the organic green light emitting layer 350G. An end of the protrusion of the first electrode 340G is electrically connected to an output of a driving transistor through the contact hole H.

Each blue pixel B includes a first electrode 340B for the blue pixel, a contact hole H for the first electrode 340B, and an organic green light emitting layer 350B. The first electrode 340B for the blue pixel has a similar shape to the organic green light emitting layer 350B, but has a protrusion extending upward differently with the organic green light emitting layer 350R. The protrusion of the first electrode 340B is electrically connected to an output of a driving transistor through the contact hole H.

Spacers 385 are disposed in every space between the red pixels R and the green pixels G and between the adjacent blue pixels B, so that the first substrate 300 and the second substrate 400 are maintained with a specific space therebetween.

Second electrodes 160 are disposed on the red pixels R, the green pixels G, and the blue pixels B.

Accordingly, each red pixel R includes an organic light emitting diode OLED which consists of the first electrode 340R for the red pixel, the organic red light emitting layer 350R, and the second electrode 360. Similarly, each green pixel G includes an organic light emitting diode OLED which consists of the first electrode 340G for the green pixel, the organic green light emitting layer 350G, and the second electrode 360. Also similarly, each blue pixel B includes an organic light emitting diode OLED which consists of the first electrode 340B for the blue pixel, the organic blue light emitting layer 350B, and the second electrode 360.

A plurality of first touch electrodes 370 and a plurality of second touch electrodes 380 are formed on the first substrate 300 with the organic light emitting diodes OLED thereon. The first touch electrodes 370 are successively arranged in a first direction (for example, in a row direction), while the second touch electrodes 380 are successively arranged in a second direction (for example, in a column direction) crossing the first direction.

Each first touch electrode 370 functions as a driving electrode of the touch screen, while each second touch electrode 380 functions as a receiving electrode of the touch screen.

Meanwhile, initial power supply lines 390 are arranged between the adjacent pixel rows on the first substrate 300. Each initial power supply line 390 is formed along upper edges of the green pixels G arranged in the horizontal direction, electrically connected to the red, green, and blue pixels R, G, and B through the contact holes H.

The initial power supply lines 390 initialize the respective pixels R, G, and B by supplying an initial power thereto during an initialization period of a non-display period. In addition, the initial power supply lines 390 functions as bridge electrodes that electrically connect the first touch electrodes 370 to each other during the non-display period except the initialization period.

Hereinafter, the initial power supply lines 390 will be referred as the bridge electrodes for ease of description.

Each first touch electrode 370 is electrically connected to the adjacent first electrode 370 through the bridge electrode 390. Each second touch electrode 380 is electrically connected to the adjacent second electrode 380 through a bridge pattern (not shown).

Hereinafter, the display device with the touch screen according to an embodiment will be described on the basis of the stacking sequence with reference to FIG. 5.

The display device with the touch screen according to an embodiment includes the first substrate 300 on which a thin film transistor TFT and an organic light emitting diode OLED are formed, and the second substrate 400 facing the first substrate 300.

The first substrate 300 may be a glass substrate. The first substrate 300 may also be either one of a film substrate and a plastic substrate, each including a polymeric organic material with flexibility. The second substrate 400 is disposed on the first substrate 300 for sealing it, and may be formed of the same material as the first substrate 300. In the case of a top emissive type or a dual emission type display device, the second substrate 400 may be formed of a transparent material, while it is formed of an opaque material in the case of a bottom emission type.

A buffer layer 305 is disposed on the first substrate 300. The buffer layer 305 prevents impurities from diffusing into the thin film transistor TFT. The buffer layer 305 may be formed of silicon nitride (SiNx), silicon oxide (SiOx), silicon oxynitride (SiOxNy), or the like. This buffer layer 305 may be omitted depending on the formation material of the first substrate 300 and the process condition.

A semiconductor pattern 310 is disposed on the buffer layer 305. The semiconductor pattern 310 is formed of a semiconductor material, and functions as an active layer of the thin film transistor TFT. This semiconductor pattern 310 includes a source region 310b, a drain region 310c, and a channel region 310a interposed between the source region 110b and the drain region 310c. The semiconductor pattern 310 may be formed of an inorganic semiconductor material or an organic semiconductor material. The source region 310b and the drain region 310c may be doped with n-type impurities or p-type impurities.

An interlayer insulating layer 315 is disposed on the semiconductor pattern 310.

A gate electrode 320 is disposed on the interlayer insulating layer 315. The gate electrode 320 is formed to cover an area corresponding to the channel region 310a of the semiconductor pattern 310.

A gate insulating layer 325 is disposed on the gate electrode 320.

A source electrode 330a and a drain electrode 330b are formed on the gate insulating layer 325. The source electrode 330a and the drain electrode 330b are respectively connected to the source region 310b and the drain region 330c of the semiconductor pattern 310 through openings formed at the interlayer insulating layer 315 and the gate insulating layer 325.

The gate electrode 320, the source electrode 330a, and the drain electrode 330b forms a thin film transistor TFT.

A passivation layer 335 (which may be an insulating layer) is disposed on the source electrode 330a and the drain electrode 330b. The passivation layer 335 covers the thin film transistor TFT, and may include one or more layers. In detail, the passivation layer 335 may include an organic insulating material which is transparent and has fluidity. Due to those properties of the material, the passivation layer 335 can flatten a top surface of the uneven substrate 300. The organic insulating material for the formation of the passivation layer 335 may be any one selected from a group including acryl resin, benzo cyclo butene (BCB), a polyimide resin (PI), polyamide resin (PA), and phenol resin.

On the passivation layer 335, a first electrode 340R for the red pixel, a bridge electrode 390 of a conductive pattern spaced apart from the first electrode 140R for the red pixel are formed. A flat side (e.g., top side) of the passivation 335 may directly contact a flat side of the first electrode 340R and a flat side of the bridge electrode 390. The flat side of the first electrode 340R and the flat side of the bridge electrode 390 may be coplanar with each other.

The first electrode 340R for the red pixel is electrically connected to the drain electrode 330b of the thin film transistor TFT through the contact hole formed at the passivation layer 335.

The bridge electrode 390 and the first electrode 340R for the red pixel are simultaneously formed with the same conductive material on the passivation layer 335. The bridge electrode 390 connects first touch electrodes 370 (which will be described later) to each other.

A pixel definition layer 345 is disposed on the first substrate 300 with the first electrode 340R for the red pixel and the bridge electrode 390 so as to define an area where an organic red light emitting layer 350R will be formed. The pixel definition layer 345 exposes a partial top surface of the first electrode 340R for the red pixel, protruding along the edges of the pixels from the first substrate 300. In addition, the pixel definition layer 345 is patterned to have a first opening through which a part of the bridge electrode 390 is exposed.

The organic red light emitting layer 350R is disposed in the area surrounded by the pixel definition layer 345. The organic red light emitting layer 350R is illustrated as a single layer in FIG. 5, but it may be formed to have a multilayer structure. For example, the organic red light emitting layer 350R may include an electron injection layer, an electron transport layer, a hole injection layer, and a hole transport layer.

A second electrode 360 is disposed on the organic red light emitting layer 350R.

In this embodiment, the first electrode 340R for the red pixel functions as an anode electrode, while the second electrode 360 functions as a cathode electrode. However, the present disclosure is not necessarily limited thereto. For example, the first electrode 340R for the red pixel may function as the cathode electrode, while the second electrode 360 functioning as the anode electrode.

Functioning as the anode electrode, the first electrode 340R for the red pixel may be formed of a transparent conductive material whose work function is high, such as Indium Tin Oxide (ITO), Indium Zinc Oxide (IZO), Zinc Oxide (ZnO), indium oxide (In2O3), etc. In the case of a top emission type display device in which an image is displayed in the opposite direction to the first substrate 300, the first electrode 340G for the red pixel may further include a reflective layer. In this case, the reflective layer may include any one of silver (Ag), magnesium (Mg), aluminum (Al), platinum (Pt), palladium (Pd), gold (Au), nickel (Ni), neodymium (Nd), iridium (Ir), chromium (Cr), lithium (Li), ytterbium (Yb), and calcium (Ca), or a compound of two or more materials selected from the enumerated materials.

Functioning as the cathode electrode, the second electrode 360 may be formed of a metallic material, such as silver (Ag), magnesium (Mg), aluminum (Al), platinum (Pt), palladium (Pd), gold (Au), nickel (Ni), neodymium (Nd), iridium (Ir), chromium (Cr), lithium (Li), and calcium (Ca). In the case of the top emission type display device with the touch screen, the second electrode 160 may also be formed of a transparent conductive material with a high work function to enable light to pass through, such as indium tin oxide (ITO), indium zinc oxide (IZO), zinc oxide (ZnO), indium oxide (In2O3), etc.

A dielectric layer 375 is disposed on the pixel definition layer 345 on which the second electrode 360 is disposed. The dielectric layer 375 functions as a reflection-preventing layer, a phase-adjusting layer, or a phase-compensating layer.

The dielectric layer 375 may include a material selected among silicon oxide (SiO2), titanium oxide (TiO2), lithium fluoride (LiF), calcium fluoride (CaF2), magnesium fluoride (MgF2), silicon nitride (SiNx), tantalum oxide (Ta2O5), niobium oxide (Nb2O5), silicon carbonitride (SiCN), molybdenum oxide (MoOx), iron oxide (FeOx), chrome oxide (CrOx), and strontium oxide (SrO). In detail, the dielectric layer 375 may be formed of one material selected among the enumerated materials, or a compound of two or more materials selected among the enumerated materials.

The dielectric layer 375 is patterned to include a second opening corresponding to the first opening of the pixel definition layer 345. The bridge electrode 390 is partially exposed through the first opening of the pixel definition layer 345 and the second opening of the dielectric layer 375.

The first opening of the pixel definition layer 345 and the second opening of the dielectric layer 375 form a bridge contact hole BH.

A first touch electrode 370 and a bridge pattern 380b are disposed on the dielectric layer 375. The bridge pattern 380b is spaced apart from the first touch electrode 370 on the dielectric layer 375, and connects the second touch electrodes (380 of FIG. 4) to each other.

The first touch electrode 370 is placed on the dielectric layer 375, functioning as a driving electrode of the touch screen. The touch electrode 370 may be formed of a conductive material selected among a group including transparent conductive material such as Indium Tin Oxide (ITO) and Indium Zinc Oxide (IZO), silver (Ag), nanowire, grapheme, and a conductive polymer.

The bridge pattern 380b is formed of the same material as the first touch electrode 370. The second touch electrodes (380 of FIG. 4) connected to each other by the bridge pattern 380b are also formed of the same material as the first touch electrodes 370.

In other words, the first touch electrodes 370, the second touch electrodes 380, and the bridge pattern 380b are simultaneously formed with the same material on the same layer.

The second substrate 400 is provided above the first substrate 300 with the first touch electrodes 370 and the bridge pattern 380b thereon.

As described above, in the display device with the touch screen according to an embodiment, the bridge electrode 390 connecting the first touch electrodes 370 to each other is simultaneously formed with the first electrode 140R for the red pixel. Accordingly, since an additional mask process for the formation of the bridge electrode 390 connecting the first and second touch electrodes 370 and 380 is omitted, the manufacturing process is simplified and manufacturing cost is also reduced.

In addition, in the display device with the touch screen according to an embodiment, each of first and second touch electrodes 370 and 380 is formed in an in-cell type. Accordingly, even if outer surfaces of the first substrate 300 and the second substrate 400 are etched by an etching process, the first and second touch electrodes 370 and 380 are not affected by such an etching. That is, the etching process for the outer surfaces of the first substrate 300 and the second substrate 400 can be performed, giving no harm to the first and second touch electrodes 370 and 380. As a result, according to an embodiment, the slimmer display device with the touch screen can be realized by reducing the overall thickness of the substrates.

Hereinafter, a manufacturing method of the display device with the touch screen according to an embodiment will be described in detail.

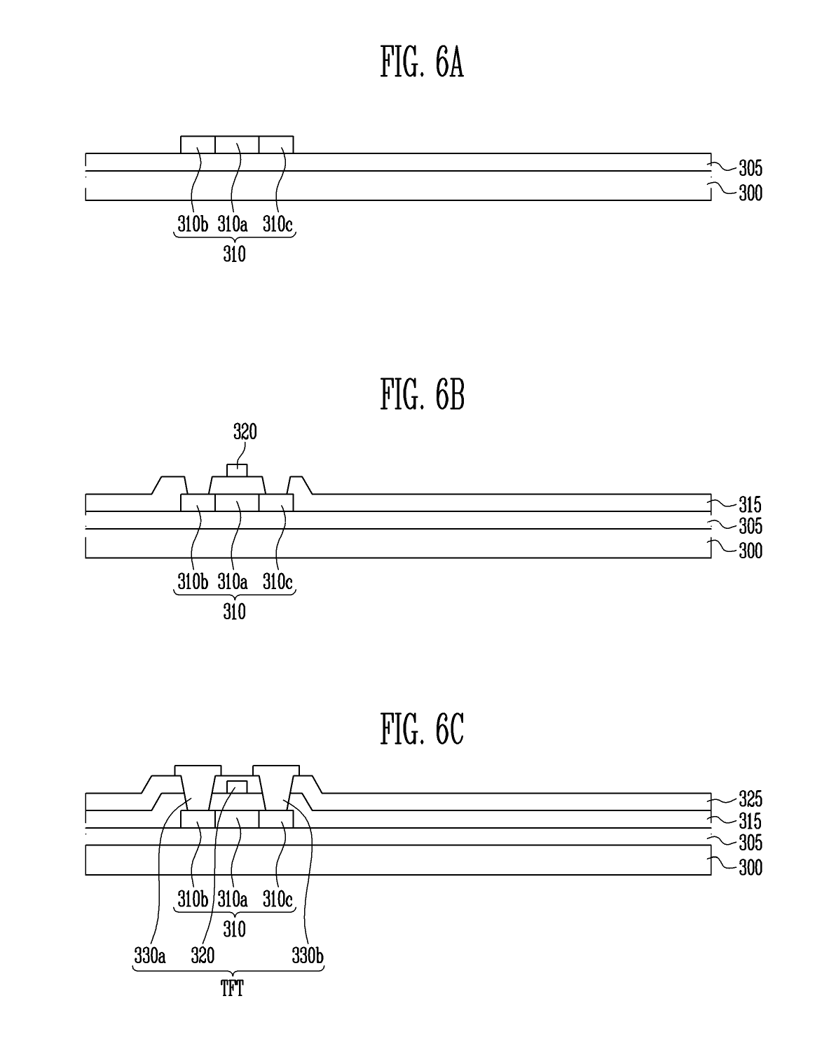

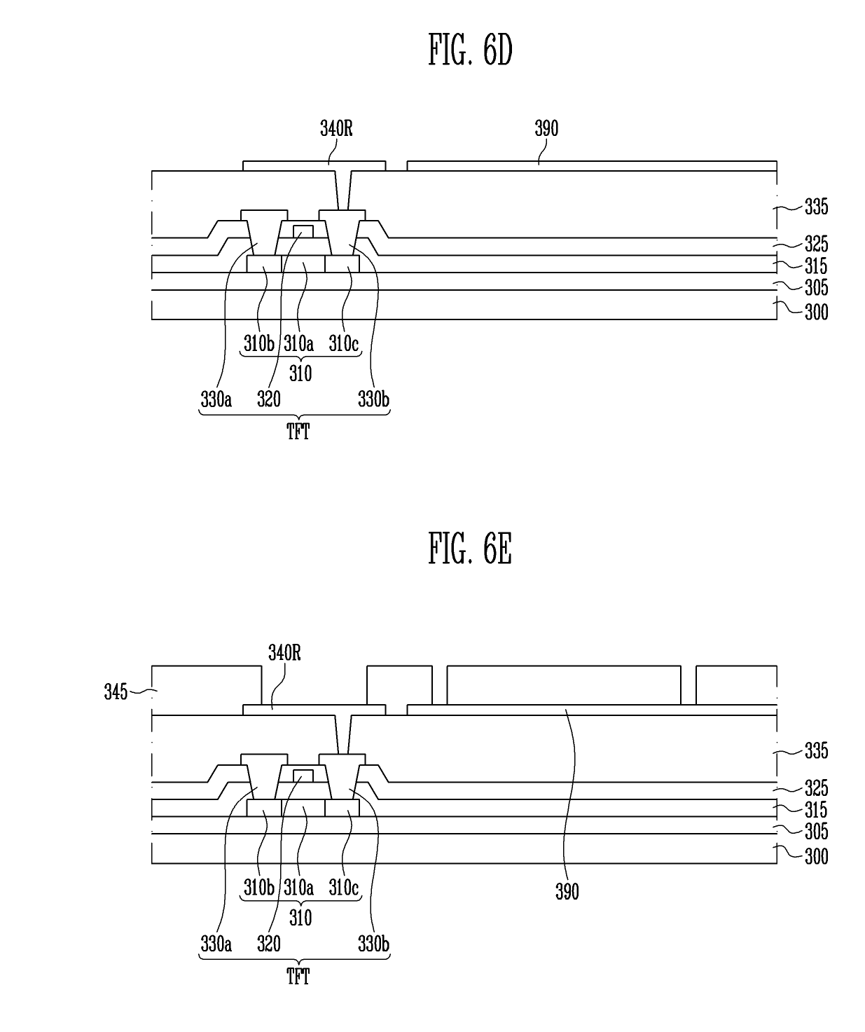

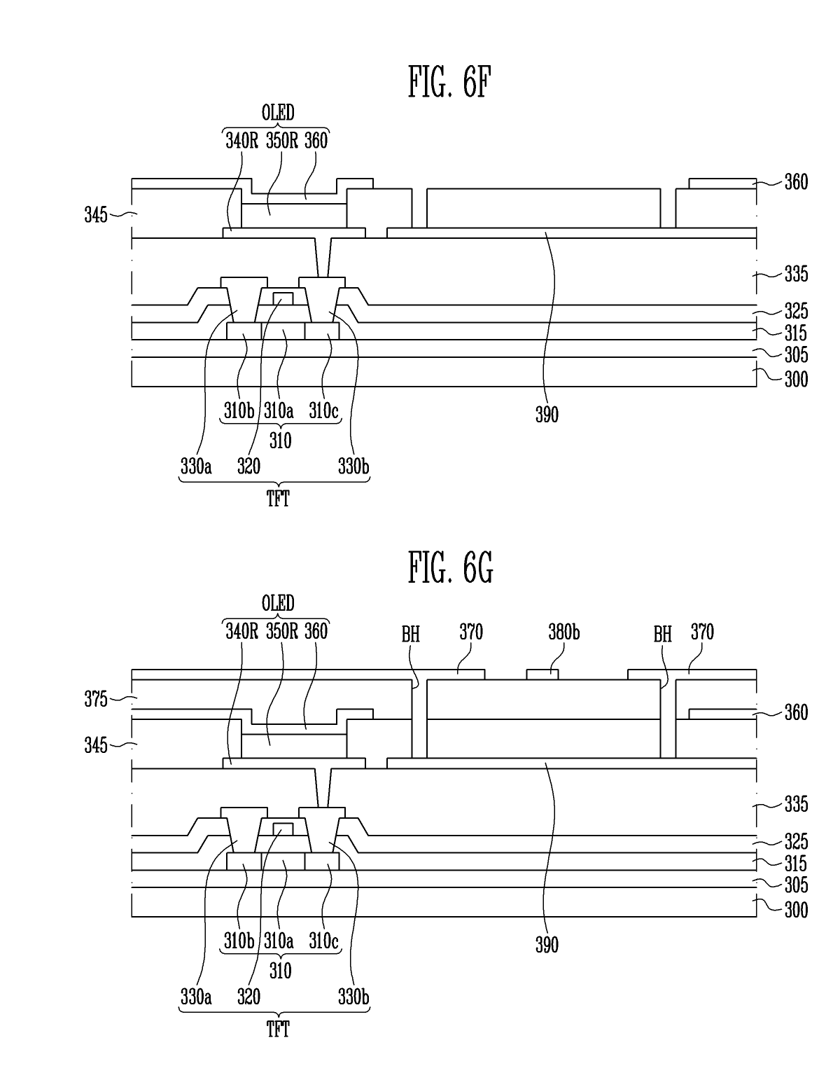

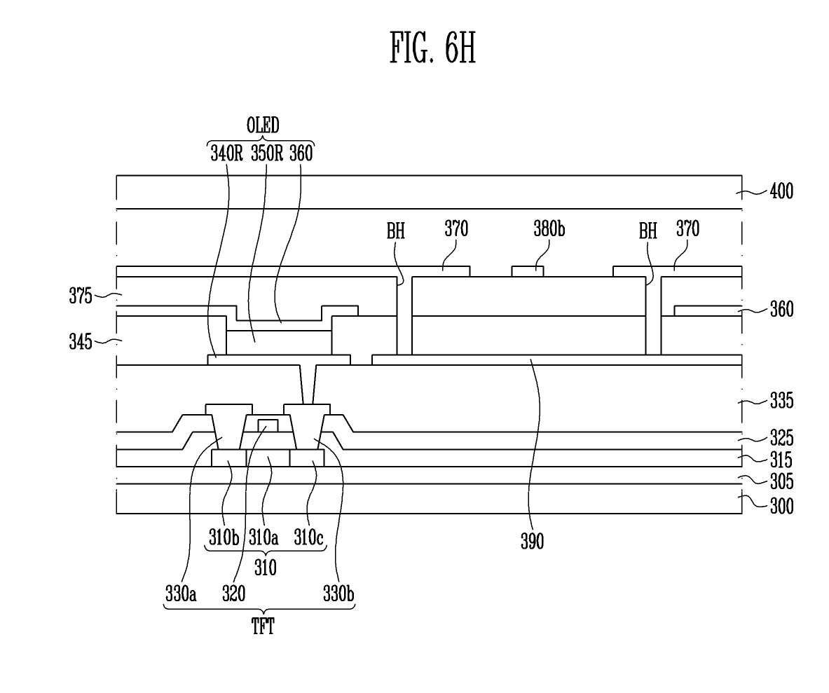

FIG. 6A to FIG. 6H are cross-sectional views for sequentially showing manufacturing processes of the display device with the touch screen according to an embodiment.

Referring to FIG. 6A, the buffer layer 305 are formed on the first substrate 300, and then the semiconductor pattern 310 is formed on the buffer layer 305.

It is preferable that the first substrate 300 is formed of a material with excellent mechanical strength and size stability. As the preferable material for the formation of the first substrate 300, glass, metal, ceramic, plastic (such as polycarbonate resin, acryl resin, polyvinyl chloride resin, polyethylene terephthalate resin, polyimide resin, polyester resin, epoxy resin, silicon resin, and fluorine resin), and so forth may be used.

The buffer layer 305 may be formed to protect driving elements that will be formed by subsequent processes from impurities, such as alkali ion, etc. which may leak from the first substrate 300. The buffer layer 305 may be formed of silicon nitride (SiNx), silicon oxide (SiOx), silicon oxynitride (SiOxNy), or the like. This buffer layer 305 may be omitted depending on the formation material of the first substrate 300.

The semiconductor pattern 310 is formed on the buffer layer 305, and includes the channel region 310a with no impurity, the source region 310b and the drain region 310c in which an impurity is injected. The impurity may comprise an n-type impurity or a p-type impurity.

Referring to FIG. 6B, the interlayer insulating layer 115 is formed to entirely cover the buffer layer 305 with the semiconductor pattern 310 thereon. Then, the gate electrode 320 is formed on the interlayer insulating layer 315.

The interlayer insulating layer 315 is formed on the semiconductor pattern 310, and includes the openings through which the source region 310b and the drain region 310c are partially exposed. The interlayer insulating layer 315 may be a single layer formed of any one selected among inorganic insulating materials such as silicon nitride (SiNx), silicon oxide (SiOx), and silicon oxynitride (SiOxNy), or a multi-layer in which two or more layers formed with the materials selected from silicon nitride (SiNx), silicon oxide (SiOx), and silicon oxynitride (SiOxNy) are included.

The gate electrode 320 is formed on the interlayer insulating layer 315 to correspond to the channel region 310a.

The gate electrode 320 may be formed of a metallic material, two or more metallic materials, or an alloy of the metallic materials. In detail, the gate electrode 320 may be a single layer formed with a material or a compound of two or more materials selected from a group including molybdenum (Mo), tungsten (W), aluminum neodymium (AlNd), titanium (Ti), aluminum (Al), silver (Ag), and an alloy thereof. Differently, to reduce wiring resistance, the gate electrode 120 may have a multilayer structure in which two or more layers formed with low resistive materials such as molybdenum (Mo), aluminum (Al), and silver (Ag) are included.

Referring to FIG. 6C, the gate insulating layer 325 is formed on the gate electrode 320. Then, the source electrode 330a and the drain electrode 330b are formed on the gate insulating layer 325.

The gate insulating layer 325 is formed of an organic insulating material or an inorganic insulating material on the interlayer insulating layer 315, and includes the openings through which the source region 310b and the drain region 310c are partially exposed.

The source electrode 330a and the drain electrode 330b may be formed of a metallic material, two or more metallic materials, or an alloy of the metallic materials. In detail, each of the source electrode 330a and the drain electrode 330b may be a single layer formed with a material or a compound of two or more materials selected from a group including molybdenum (Mo), tungsten (W), molybdenum tungsten (MoW), aluminum neodymium (AlNd), titanium (Ti), aluminum (Al), silver (Ag), and an alloy thereof. Differently, to reduce wiring resistance, each of the source electrode 330a and the drain electrode 330b may have a multilayer structure in which two or more layers formed with low resistive materials such as molybdenum (Mo), aluminum (Al), and silver (Ag) are included.

Referring to FIG. 6D, the passivation layer 335 is formed on the source electrode 330a and the drain electrode 330b. Then, the first electrode 340R for the red pixel, and bridge electrode 390 are formed on the first substrate 300 with the passivation layer 335 thereon.

The passivation layer 335 includes a contact hole through which the drain electrode 330b is partially exposed. The contact hole of the passivation layer 335 is formed through a photolithography process. The passivation layer 335 may be formed of an organic insulating material which is transparent and has fluidity so as to flatten a top surface of the uneven first substrate 300.

The first electrode 340R for the red pixel is electrically connected to the drain electrode 330b through the contact hole formed at the passivation layer 335.

The bridge electrode 390 is spaced apart from the first electrode 340R for the red pixel on the passivation layer 335. The bridge electrode 390 and the first electrode 340R for the red pixel are formed at the same time, and include the same conductive material. In detail, the bridge electrode 390 and the first electrode 340R for the red pixel are formed of a transparent conductive material whose work function is high, such as indium tin oxide (ITO), indium zinc oxide (IZO), zinc oxide (ZnO), indium oxide (In2O3), etc.

Referring to FIG. 6E, the pixel definition layer 345 is formed on the first substrate 300 with the first electrode 340R for the red pixel and the bridge electrode 390 so as to define an area where an organic red light emitting layer 350R will be formed. The pixel definition layer 345 exposes a partial top surface of the first electrode 340R for the red pixel, protruding along the edges of the pixels from the first substrate 300.

In addition, the pixel definition layer 345 is patterned to have the first opening through which a part of the bridge electrode 390 is exposed.

Referring to FIG. 6F, the organic red light emitting layer 350R is formed in the area surrounded by the pixel definition layer 345. Then, the second electrode 360 is formed on the organic red light emitting layer 350R.

The organic red light emitting layer 350R includes a layer formed of an organic light emitting material. In general, the organic red light emitting layer 350R has a multilayer structure.

The second electrode 360 may be formed of a metallic material, such as silver (Ag), magnesium (Mg), aluminum (Al), platinum (Pt), palladium (Pd), gold (Au), nickel (Ni), neodymium (Nd), iridium (Ir), chromium (Cr), lithium (Li), and calcium (Ca). In the case of the top emission type display device with the touch screen, the second electrode 360 may also be formed of a transparent conductive material with a high work function to enable light to pass through, such as indium tin oxide (ITO), indium zinc oxide (IZO), zinc oxide (ZnO), indium oxide (In2O3), etc.

The first electrode 340R for the red pixel, the organic red light emitting layer 350R, and the second electrode 360 form an organic light emitting diode OLED.

Referring to FIG. 6G, the dielectric layer 375 is formed on first substrate 300 on which the organic red light emitting layer 350R is formed. Then, the first touch electrode 370 and the bridge pattern 380b are formed on the dielectric layer 375. The bridge pattern 380b is spaced apart from the first touch electrode 370 on the dielectric layer 375, and connects the second touch electrodes (380 of FIG. 4) to each other.

The dielectric layer 375 is patterned to include a second opening corresponding to the first opening of the pixel definition layer 345. The bridge electrode 390 is partially exposed through the first and second openings. The first opening of the pixel definition layer 345 and the second opening of the dielectric layer 375 form a bridge contact hole BH.

The first touch electrode 370 is electrically connected to the adjacent first touch electrode 370 through the bridge contact hole BH, and thus the connected first touch electrodes 370 can function as driving electrodes of the touch screen. The second touch electrode 380 is electrically connected to the adjacent second touch electrode 380 through the bridge pattern 380b, and thus the connected second touch electrodes 380 can function as receiving electrodes of the touch screen.

Referring to FIG. 6H, after the first touch electrode 370 and the bridge pattern 380b are formed, the second substrate 400 is provided. The second substrate 400 serves as an encapsulation member for separating the first and second touch electrodes 370 and 380 from the outside.

As described above, in the display device with the touch screen according to an embodiment, the touch electrodes and the first electrodes of the organic light emitting diode OLED are formed at the same time. Accordingly, since no additional mask process for the formation of the touch electrodes is required, the manufacturing process may be simplified and/or related manufacturing cost may be minimized.

Example embodiments have been disclosed. Although specific terms are employed, they are to be interpreted in a generic and descriptive sense and not for purpose of limitation. In some examples, as would be apparent to one of ordinary skill in the art as of the filing of the present application, features, characteristics and/or elements described in connection with a particular embodiment may be used singly or in combination with features, characteristics and/or elements described in connection with other embodiments unless otherwise specifically indicated. Various changes to the example embodiments in form and details may be made without departing from the spirit and scope set forth in the following claims.

What is claimed is:

1. A display device with a touch screen comprising:
a first substrate;
a thin film transistor disposed on the first substrate;
a display element that includes a first electrode connected to the thin film transistor, and a second electrode disposed on the first electrode;
a plurality of first touch electrodes that are spaced apart from the first electrode, each of which extends in a column direction on the first substrate;
a plurality of second touch electrodes disposed on the first substrate in parallel with the first electrodes;
a pixel definition layer that is disposed on the first electrode, the plurality of first touch electrodes and the plurality of second touch electrodes and that includes bridge contact holes through which the respective first touch electrodes are partially exposed;
a bridge electrode that is disposed on the pixel definition layer and that connects the first touch electrodes exposed through the bridge contact holes; and
a second substrate facing the first substrate,
wherein the first electrode, the first touch electrodes and the second touch electrodes are formed of the same conductive material on the same layer.

2. The display device of claim 1, wherein the bridge electrode and the second electrode are formed of the same conductive material on the same layer.

3. The display device of claim 1, wherein the display element further includes an organic light emitting layer that emits light with a specific color by the first electrode and the second electrode.

4. The display device of claim 3, wherein the first electrode includes an anode electrode, and wherein the second electrode includes a cathode electrode.

5. A display device with a touch screen comprising:
a first substrate;
a thin film transistor disposed on the first substrate;
a display element that includes a first electrode connected to the thin film transistor, and a second electrode disposed on the first electrode;
a bridge electrode spaced apart from the first electrode on the first substrate;
a pixel definition layer that is disposed on the first electrode and the bridge electrode and that includes first openings through which the bridge electrode is partially exposed;
a dielectric layer that is disposed on the pixel definition layer and that includes second openings corresponding to the first openings of the pixel definition layer;
a plurality of first touch electrodes disposed on the dielectric layer and extended in a first direction;
a plurality of second touch electrodes spaced apart from the first touch electrodes and extended in a second direction crossing the first direction; and
a second substrate facing the first substrate,
wherein the first touch electrodes adjacent to each other are connected to the bridge electrode through the first openings and second openings.

6. The display device of claim 5, wherein the first electrode and the bridge electrode are formed of the same conductive material on the same layer.

7. The display device of claim 5, wherein the first touch electrodes and the second touch electrodes are formed of the same conductive material on the same layer.

8. The display device of claim 5, wherein the bridge electrode includes an initialization power line for supplying an initialization power to the thin film transistor.

9. The display device of claim 5, wherein the display element further includes an organic light emitting layer that emits light with a specific color by the first electrode and the second electrode.

10. The display device of claim 9, wherein the first electrode includes an anode electrode, and wherein the second electrode includes a cathode electrode.

11. A method for manufacturing a display device with a touch screen, the method comprising:
forming a thin film transistor on a first substrate;
forming a passivation layer on the thin film transistor;
forming a first electrode connected to the thin film transistor on the passivation layer and forming a first conductive pattern spaced apart from the first electrode on the passivation layer;
forming a pixel definition layer with contact holes on the first electrode and the first conductive pattern, the first conductive pattern being partially exposed through the contact holes;
forming a second electrode disposed on the pixel definition layer and partially overlapped with the first electrode, and forming a second conductive pattern disposed on the pixel definition layer and insulated from the second electrode; and
forming a second substrate facing the first substrate on the first substrate.

12. The method of claim 11, wherein the first conductive pattern includes a plurality of first touch electrodes spaced apart from the first electrode and extended in a column direction, and a plurality of second touch electrodes formed in parallel with the first electrodes, and wherein the respective first touch electrodes are partially exposed through the contact holes of the pixel definition layer.

13. The method of claim 12, wherein the second conductive pattern includes a bridge electrode that connects the first touch electrodes exposed through the contact holes of the pixel definition layer.

14. The method of claim 12, wherein the first electrode, the plurality of first touch electrodes and the plurality of second touch electrodes are formed of the same conductive material on the same layer.

15. The method of claim 11, wherein the second electrode and the second conductive pattern are formed of the same conductive material on the same layer.

16. The method of claim 11, wherein the second conductive pattern includes a plurality of first touch electrodes that are disposed on a dielectric layer placed on the pixel definition layer and that are extended in a first direction, and a plurality of second touch electrodes that are spaced apart from the first touch electrodes and that are extended in a second direction crossing the first direction.

17. The method of claim 16, wherein the first conductive pattern includes a bridge electrode that connects the adjacent first touch electrodes to each other through the contact holes.

18. The method of claim 11, further comprising forming an organic light emitting layer for emitting light with a specific color between the first electrode and the second electrode.
